(19) United States
(12) Patent Application Publication
(10) Pub. No.: US 2008/0054534 A1
(43) Pub. Date: Mar. 6, 2008

(54) Tire Holding Unit, Molding Dies Having the Same, and Tire Vulcanization Method Using the Same

(76) Inventor: Takeshi Sugiyama, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 11/631,491

(22) PCT Filed: Jul. 6, 2005
(86) PCT No.: PCT/JP05/12458

§ 371 Date: Jul. 12, 2007

(30) Foreign Application Priority Data
Jul. 8, 2004 (JP) 2004-201675

(51) Int. Cl. B29D 30/28

(52) U.S. Cl. 264/501; 425/33

(57) ABSTRACT

The purpose is to provide a convenient-to-use tire holding unit which allows vulcanization molding to be efficiently carried out, and prevents a green tire from being deformed, molding dies having the same, and a tire vulcanization method using the same.

Molding dies 12 have a tire holding unit 14 for holding a green tire 30; a lower die main body 28; and an upper die main body 22. The tire holding unit 14 includes a center post 16 which is freely mountable to and dismountable from the molding dies 12; a bladder 18 mounted to the center post 16; and a central upper die part 24 and a central lower die part 26 mounted to the center post 16 at either end side of the bladder, respectively. The central upper die part 24 is freely mountable to and dismountable from the center post 16. In addition, the die-radial outside edge 26E of the central lower die part 26 is located at an outer side in a die radial direction of a location which corresponds to half the tire section height H of the molding dies 12. The upper die main body 22 and the central upper die part 24 constitute an upper die 21, and the lower die main body 28 and the central lower die part 26 constitute a lower die 29.

### TECHNICAL FIELD

The present invention relates to a tire holding unit for holding an unvulcanized tire, molding dies having the same, and a tire vulcanization method using the same, and more particularly, relates to a tire holding unit which is most suitable especially for a high-weight tire, molding dies having the same, and a tire vulcanization method using the same.

### BACKGROUND ART

For vulcanization molding of a pneumatic tire for use with passenger cars, molding dies of a type that are moved only in one direction to be opened and closed are generally used such that a green tire held by an inflated bladder is carried and placed in the lower die. However, in manufacturing a high-weight tire (a high-mass tire), such as a truck vehicle tire or a construction vehicle tire, if this type of molding die is used, a deformation of the green tire due to its own weight, such as drooping, is caused at the time of carriage, which makes it impossible to satisfactorily accommodate the green tire in the molding dies, with the result that it is not possible to achieve uniform vulcanization. Therefore, for vulcanization molding of this kind of high-weight tire, molding dies constituted by three-division members of an upper die, a middle die, and a lower die are used, the upper die being moved in the vertical direction and the middle die in the horizontal direction for opening and closing the dies (see, for example, patent document 1).

Hereinbelow, a conventional molding die for use in manufacturing a high-weight tire will be described with reference to an example, and an attached drawing.

As shown in FIG. 5, a conventional molding die 80 for vulcanizing a high-weight tire includes a center post 86; a bladder 88 mounted to the center post 86; an upper die 81 for molding one of the tire side faces; a lower die 89 for molding the other side face; and a middle die 85 for molding a tread part.

In order to carry out vulcanization molding with the molding die 80, a green tire 90 is placed on the lower die 89; and the dies are put into a closed state using the middle die 85 and the upper die 81, and vulcanization molding is carried out. The internal pressure of green tire 90 is set at a predetermined value by means of the bladder 88.

Patent document 1: Japanese Patent Application Laid-Open No. 1-301233

### DISCLOSURE OF THE INVENTION

Problems to Be Solved by the Invention

Incidentally, moving the upper die in the vertical direction and the middle die in the horizontal direction in this way has presented the problems that the apparatus configuration is rendered complicated; pattern design is restricted; and, further, improvement in productivity is hindered. In addition, there has arisen another problem that, when the green tire is carried to the lower die and placed thereon, the green tire tends to be deformed under its own weight.

The present invention has been made in view of the above-stated situation, and the purpose thereof is to provide a convenient-to-use tire holding unit which allows the vulcanization molding to be efficiently carried out, and prevents the green tire from being deformed, molding dies having the same, and a tire vulcanization method using the same.

Means to Solve the Problems

The present inventor has noticed that, when vulcanizing a pneumatic tire for use with passenger cars, it is effective to control the air filling pressure for the bladder at a low value in order to be able to uniformly place the green tire in the molding dies. However, the weight of a high-weight tire is heavy, and thus lowering the air filling pressure for the bladder causes a deformation of the green tire mainly due to drooping, which makes it impossible to carry out uniform vulcanization. Therefore, for a high-weight tire, the air filling pressure for the bladder cannot be lowered.

Then, after intensive research, the present inventor conceived of assembling a flange-like die part extending from the bead to the rim line at the center post for performing molding to allow a high-weight green tire to be supported by this flange-like die part during carriage. However, the result was that drooping was only slightly alleviated, and the problem was not solved.

Then, after intensive research, the present inventor conceived of further widening the flange-like die part, and conducted further investigation to accomplish the present invention.

The invention according to claim 1 provides a tire holding unit, including: a center post which is disposed at a center of molding dies for vulcanization; a bladder which is mounted to the center post; and a central upper die part and a central lower die part which form a part of the molding dies, and are mounted to the center post on either end side of the bladder, respectively, wherein the central upper die part is freely mountable to and dismountable from the center post, and an outside edge in a radial direction of the central lower die part is located at an outer side in the die radial direction of a location that corresponds to half a tire section height of the molding dies.

The central lower die may be discoid or radial when viewed from the center post direction.

In order to use the tire holding unit of the invention according to claim 1 for vulcanization molding, the center post is removed from the molding dies, and a green tire is fitted to the center post in a state in which the central lower die part is mounted to this center post.

Then, the central upper die part is mounted to the center post, and the bladder is inflated in the green tire to provide a prescribed air filling pressure for supporting the green tire from the inside of the tire, whereby the green tire is held by the tire holding unit.

Then, in a state in which the tire holding unit is oriented to be loaded on the molding dies, i.e., in a state in which the central lower die part is at a lower side, and the central upper die part is at an upper side, the tire holding unit which holds the green tire is carried to the molding dies.

In this state, the outside edge in a radial direction of the die (die-radial outside edge) of the central lower die part is located at an outside in a die radial (tire-radial) direction of a location which corresponds to half the tire section height of the molding dies. Thereby, when carrying out the above-stated carriage, even if the weight of the green tire is heavy, deformation of the green tire under its own weight, such as drooping, can be prevented.

If the die-radial outside edge of the central lower die part were not located die-radially outside of the location which corresponds to half the section height for the molding dies, the green tire would tend to be deformed under its own weight, which is undesirable.

The invention according to claim 2 provides molding dies which have the tire holding unit according to claim 1 as a constituting member.

Thereby, even when the tire holding unit according to claim 1 or 2 that has been carried to the molding dies is loaded on the molding dies for vulcanization molding, the vulcanization can be uniformly and satisfactorily carried out.

Incidentally, with the tire holding unit according to claim 1, the die-radial outside edge of the central lower die part is located tire-radially outside of the location which corresponds to half the tire section height for the molding dies, and thus during carriage, the deformation of the green tire under its own weight is prevented. Therefore, even if a green tire of high weight is carried in a state in which the internal pressure of the bladder is lower than normal, the green tire will not be deformed under its own weight. On the other hand, if the internal pressure of the bladder is lower, the diameter of the green tire which is held by the tire holding unit can be made smaller. Therefore, even if a configuration is adopted in which the die part which forms the tread part is integrally formed with the upper and lower dies, and the number of moving directions is limited to two, instead of a configuration in which the die members constituting the molding dies are individually moved in the vertical direction and the horizontal direction, respectively, the internal pressure of the bladder can be reduced, and the green tire can be loaded into the molding dies from above.

Further, the invention according to claim 3 provides molding dies of claim 2 which are used for vulcanization molding of a high weight tire, wherein the die member which is butted against the tire external surfaces is constituted by an upper die and a lower die; the central upper die part constitutes a part of the upper die; and the central lower die part constitutes a part of the lower die.

Thereby, the degree of freedom for pattern design is remarkably increased, and the configuration of the molding dies is simplified, resulting in the productivity being improved.

The invention according to claim 4 provides a tire vulcanization method using the molding dies according to claim 3, including: a green tire being fitted to the center post which has been removed from the molding dies, the green tire being sandwiched between the central upper die part and the central lower die part, and the bladder being inflated in the green tire with an air filling pressure of 50 kPa or lower, whereby the green tire is held by the tire holding unit according to claim 1, the tire holding unit being carried to above the lower die, and being lowered to load the green tire and the tire holding unit onto the lower die, and the molding dies being closed for vulcanization.

As described above deformation of the green tire under its own weight during carriage is prevented by the central lower die part. Therefore, even for a high-weight tire, the air filling pressure of the bladder can be reduced to 50 kPa or lower, which is approximately half or less compared to that for a conventional system.

Therefore, even if, by the invention according to claim 4, the variation in growth of the green tire is held to half or less compared to that for a conventional system, satisfactory vulcanization molding can be carried out.

### EFFECT OF THE INVENTION

Because the present invention is configured as described above, the vulcanization molding can be efficiently carried out, and a convenient-to-use tire holding unit with which the deformation of the green tire is prevented, molding dies having the same, and a tire vulcanization method using the same can be realized.

### BRIEF DESCRIPTION OF THE DRAWINGS

FIG. 1 is a sectional view in a tire radial direction illustrating a green tire before being fitted to a center post in one embodiment pertaining to the present invention;

FIG. 2 is a side sectional view illustrating the green tire being held in a tire holding unit in one embodiment pertaining to the present invention;

FIG. 3 is a side sectional view illustrating the green tire held in the tire holding unit in one embodiment pertaining to the present invention;

FIG. 4 is a side sectional view illustrating the tire holding unit which holds the green tire having been set in molding dies in one embodiment pertaining to the present invention; and

FIG. 5 is a side sectional view illustrating vulcanization molding being carried out with conventional molding dies.

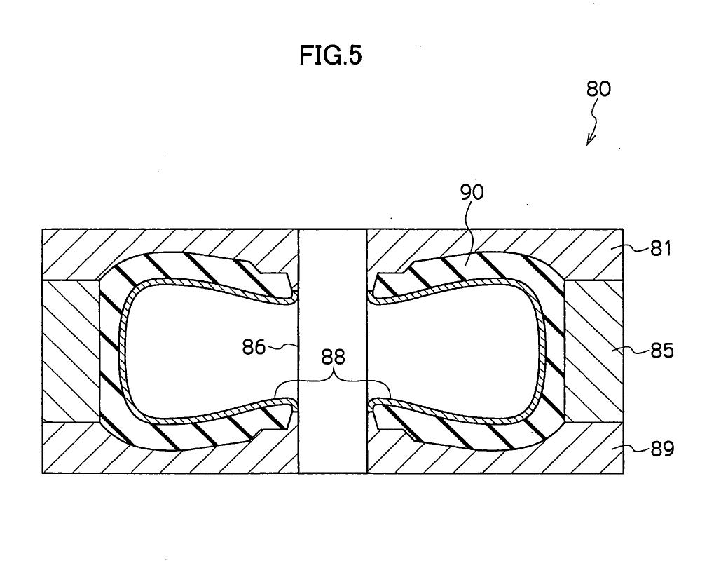

### BEST MODE FOR CARRYING OUT THE INVENTION

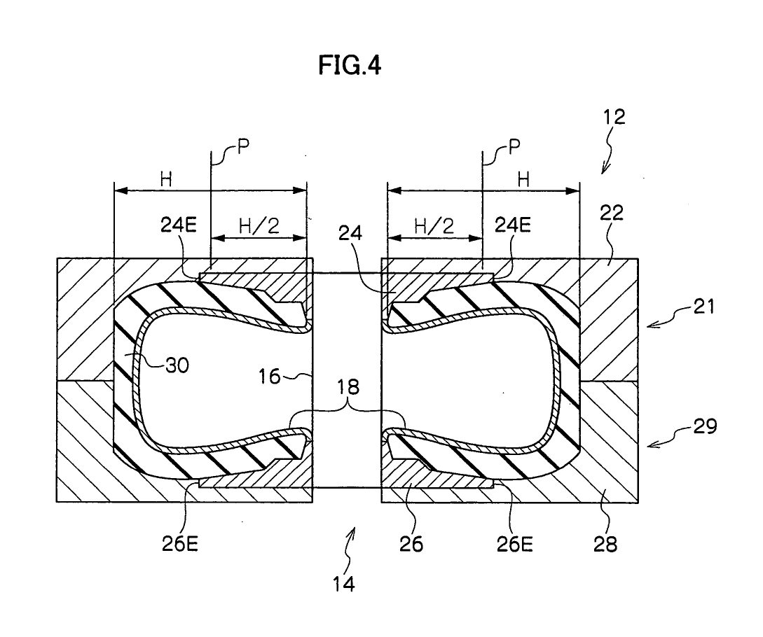

Hereinbelow, an embodiment of the present invention will be described. As shown in FIG. 4, molding dies 12 pertaining to one embodiment of the present invention are dies for ultra-large ORR tires, including a tire holding unit 14 which is freely mountable to and dismountable from the dies.

The tire holding unit 14 includes a center post 16 which is freely mountable to and dismountable from the molding dies 12, and a bladder 18 which is mounted to the center post 16. In addition, the tire holding unit 14 includes a central upper die part 24 and a central lower die part 26 which constitute the molding dies 12 for tire vulcanization molding, respectively mounted to the center post 16 at either end side of the bladder. Both of the central upper die part 24 and the central lower die part 26 are freely mountable to and dismountable from the center post 16.

Both of the die-radial outside edges 24E, 26E of the central lower die part 26 and the central upper die part 24 are located die-radially outside of the die-radial height location P which corresponds to half the tire section height H for the molding dies 12. The central upper die part 24 and the central lower die part 26 are substantially discoid when viewed from top, and both of the respective die-radial outside edges 24E, 26E are circumferential.

As is well known, the tire section height H is a dimension measured along the tire radial direction from the datum line, which is parallel with the tire rotation axis and passes through the point of intersection between a straight line passing through the bead seat and an extension line of the internal wall surface of the rim flange that is perpendicular to the tire rotation axis, to the tire-radially outermost location.

In addition, the molding dies 12 include an upper die main body 22 and a lower die main body 28 which are vertically divided substantially at the tire equatorial plane of the tire which is accommodated therein, and the upper die main body 22 is vertically movable such that the tire can be placed in and removed from the molding dies 12. With this configuration, the die member which is butted against the tire outside surfaces is constituted by an upper die 21 made up of the upper die main body 22 and the central upper die part 24, and a lower die 29 made up of the lower die main body 28 and the central lower die part 26.

In order to carry out vulcanization molding using the molding dies 12 pertaining to the present embodiment, the center post 16 is first removed from the molding dies 12. To this center post 16, the central lower die part 26 is mounted, being oriented in the same direction as when loaded on the molding dies 12.

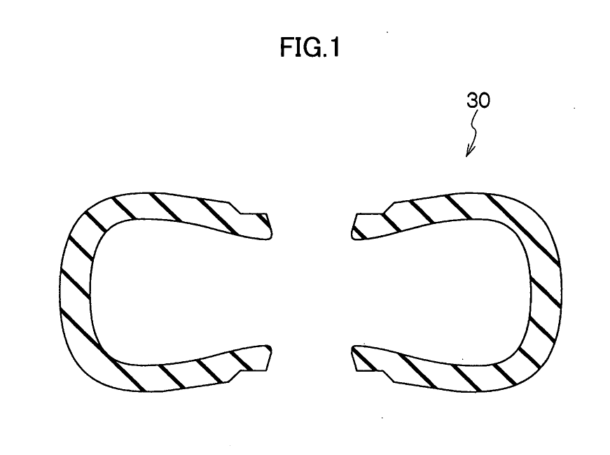

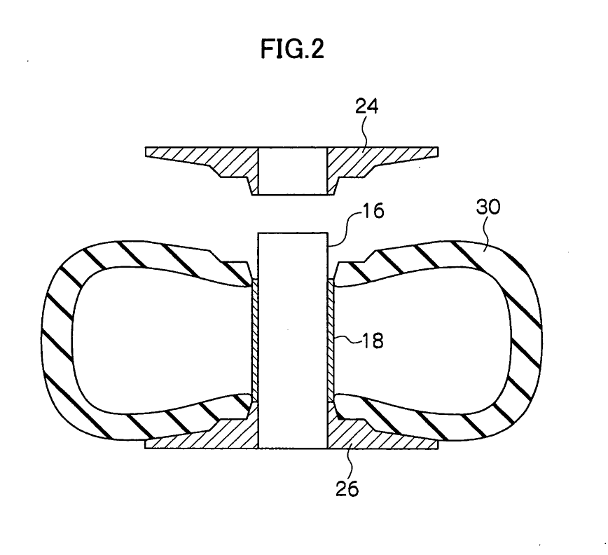

Then, a green tire 30 (see FIG. 1) is fitted to the center post 16 to cause the central lower die part 26 to support this green tire 30 (see FIG. 2).

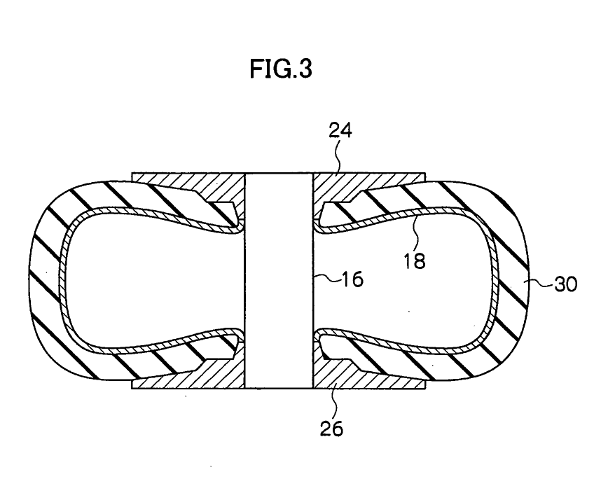

Further, as shown in FIG. 3, the central upper die part 24 is mounted to the center post 16 to sandwich the green tire 30 between the central upper die bladder 18 and the central lower die part 26, and the bladder 18 is inflated with an air filling pressure of 50 kPa or lower to support the green tire 30 from the inside of the tire, thereby holding the green tire 30 with the tire holding unit 14.

Then, by raising the upper die main body 22, the molding dies 12 are opened, and the tire holding unit 14 is carried to above the lower die main body 28 to be lowered to load the green tire 30 held by the tire holding unit 14 to the lower die main body 28 by insertion.

Then, by lowering the upper die main body 22, the molding dies 12 are closed (see FIG. 4).

Further, metal fittings (not shown) are used for tightening the dies from the outside, and the internal pressure of the bladder 18 is further increased to cause the green tire 30 to be tightly contacted with the die surfaces of the molding dies 12, and the vulcanization molding is carried out.

The tread pattern may be formed by carrying out cutting, or the like, after the vulcanization molding rather than performing the formation thereof with the molding dies 12.

As described above, in the present embodiment, the die-radial outside edge 26E of the central lower die part 26 is located tire-radially outside (die-radially outside) of the die-radial height location P which corresponds to half the tire section height H of the molding dies 12, and thus deformation of the green tire 30 during carriage under its own weight can be fully prevented. In addition, the internal pressure of the bladder 18 is at 50 kPa or lower, and the tire diameter of the green tire 30 which is carried is relatively small.

Thereby, when carrying the tire holding unit 14 to the lower die main body 28 in this state, deformation of the green tire 30 under its own weight, such as drooping, can be prevented even if the weight of the green tire 30 is heavy. In addition, even with dies of the type in which the molding dies 12 are opened and closed by moving only in the vertical direction, deformation of the green tire 30 during carriage under its own weight, such as drooping, can be prevented, which allows uniform vulcanization, resulting in the productivity being improved. In addition, even for the green tire 30 from which a high-weight tire is to be molded, the air filling pressure to the bladder 18 may be set at 50 kPa or lower, which is approximately half or less of that which is conventionally used, and thus the variation in inflation of the green tire 30 can be held to half or less of a conventional one, which allows vulcanization molding to be satisfactorily carried out.

Hereinabove, the embodiment of the present invention has been described, however, the above embodiment is only one example, and it may be variously modified for embodiments without deviation from the spirit of the invention. In addition, it is needless to say that the scope of the right of the present invention is not limited to the above-stated embodiment.

### INDUSTRIAL APPLICABILITY

As described above, the tire holding unit pertaining to the present invention, the molding dies having the same, and the tire vulcanization method using the same allow vulcanization molding to be efficiently carried out, and are very suitable for use as those which are capable of preventing deformation of the green tire.

### EXPLANATION OF REFERENCE NUMERALS AND SIGNS IN THE DRAWINGS

12: Molding dies
14: Tire holding unit
16: Center post
18: Bladder
21: Upper die
24: Central upper die part
26: Central lower die part
29: Lower die
30: Green tire
80: Molding dies
81: Upper die
86: Center post
88: Bladder
89: Lower die
90: Green tire

What is claimed is:

1. A tire holding unit, comprising:
a center post which is disposed at a center of molding dies for vulcanization;
a bladder which is mounted to the center post; and
a central upper die part and a central lower die part which form a part of the molding dies, and are mounted to the center post on either end side of the bladder, respectively,
wherein
the central upper die part is freely mountable to and dismountable from the center post, and
an outside edge in a radial direction of the central lower die part is located at an outer side in the die radial direction of a location that corresponds to half a tire section height of the molding dies.

2. Molding dies comprising the tire holding unit according to claim 1 as a constituent member.

3. The molding dies of claim 2 which are used for vulcanization molding of a high weight tire, wherein
a die member that is butted against outside surfaces of the tire is structured by an upper die and a lower die,
the central upper die part constitutes a part of the upper die, and
the central lower die part constitutes a part of the lower die.

4. A tire vulcanization method using the molding dies according to claim 3, comprising:
a green tire being fitted to the center post which has been removed from the molding dies,
the green tire being sandwiched between the central upper die part and the central lower die part, and the bladder being inflated in the green tire with an air filling pressure of 50 kPa or lower, whereby the green tire is held by the tire holding unit according to claim 1,
the tire holding unit being carried to above the lower die, and being lowered to load the green tire and the tire holding unit onto the lower die, and
the molding dies being closed for vulcanization.
